(19) United States
(12) Patent Application Publication
(10) Pub. No.: US 2007/0171446 A1
(43) Pub. Date: Jul. 26, 2007

(54) Font downloading apparatus, font downloading program, font downloading method and recording medium

(75) Inventors: Koichi Yamamoto, Nara (JP); Kayo Okamoto, Kyoto (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/656,694

(22) Filed: Jan. 22, 2007

(30) Foreign Application Priority Data
Jan. 20, 2006 (JP) 2006-12448

(51) Int. Cl. G06K 15/02

(52) U.S. Cl. 358/1.11; 358/1.15

(57) ABSTRACT

When a printing condition is assigned before printing out, a printing condition setting interface part displays a printing condition setting screen including a font processing selecting screen. An operator can select how to process fonts from among predetermined items in the font processing selecting screen, when the fonts that are not held in an output device exist in a document. In addition, the operator assigns a desired size and can thereby set so as to replace the fonts having a size no larger than the assigned size with the fonts held in the output device. A converting part converts a document that has been created in an application part into a print job including a control code and image data and the like for the output device, based on a condition that has been set in the printing condition setting screen.

### CROSS-REFERENCE TO RELATED APPLICATION

This application claims priority to Japanese Patent Application No. JP 2006-12448, which was filed on Jan. 20, 2006, the contents of which, are incorporated herein by reference, in their entirety.

### BACKGROUND OF THE INVENTION

1. Field of the Invention

The present invention relates to a font downloading apparatus and program for downloading font data necessary for printing out to output devices such as network printers, a font downloading method, and a recording medium.

2. Description of the Related Art

Recently, a user can generally select various kinds of-fonts (font types) in documentation with a personal computer (hereinafter referred to as a “PC”) . Accordingly, documents that have been created with a PC may include various kinds of fonts. In addition, the PC is generally connected to an output device such as a network printer to carry out printing out of the documents that have been created with the PC, from the output device when needed. However, fonts that are selectable in documentation with the PC do not necessarily exist in fonts held by the output device (hereinafter referred to as “printer fonts”). In such a case, the output device cannot carry out printing out of the documents with the fonts identical to the fonts that have been selected in documentation with the PC. Hereinafter, the-fonts that exist in the document printing out of which has been requested from the PC to the output device will be referred to as “request fonts”.

Consequently, when the request fonts do not exist in the printer fonts, printing out is conventionally performed by using the printer fonts having a shape close to the request fonts, or by using data indicating a shape of the request fonts (font shape data), which has been downloaded from the PC to the output device.

For example, a method for preparing a table (an alternative font table) that relates the request fonts to the printer fonts in a predetermined manner is known as a method for printing out using the printer fonts having a shape close to the request fonts. In accordance with this method, data for identifying a font, such as information indicating a character code and a font type (hereinafter referred to as “font identification data”), is transmitted from the PC to the output device. Then, the font shape data of fonts corresponding to the font identification data that has been transmitted from the PC (alternative fonts) is read out from a memory part (the memory part for storing the font shape data of the printer fonts) of the output device, to perform image development in a printing image forming part based on the font shape data. Japanese Unexamined Patent Publication JP-A 10-171790 (1998) discloses a method for calculating a predetermined distance using information (data) of a longitudinal stem width and a horizontal stem width of characters to select the printer fonts having the shortest distance from among the request fonts as the alternative fonts for printing out.

As a method for downloading the font shape data of the request fonts from the PC to the output device, a method for downloading the font shape data of the request fonts in a outline format and a method for downloading such data in a bitmap format are known. In accordance with these methods, data for indicating a shape itself of a character is transmitted from the PC to the output device. Then, image development is performed in the print image forming part based on the font shape data that has been transmitted from the PC. Japanese Unexamined Patent Publication JP-A 2000-225756 discloses a font downloading apparatus for downloading in a bitmap format when image quality has a high priority, and downloading in an outline format when printing speed has a high priority. Moreover, there are some output devices for transmitting image data rather than font data from the PC to the output device to print a font as a graphical font.

However, when the printer fonts are used as the alternative fonts, printing speed is increased, at the same time, differences in appearance between fonts displayed on a screen and fonts printed on a printed material are increased. On the other hand, when the font shape data of the request fonts is downloaded from the PC to the output device, the differences in appearance therebetween are decreased, at the same time, increased data traffic lowers the printing speed.

### SUMMARY OF THE INVENTION

Hence an object of the invention is to provide an apparatus, program, and method for downloading font data to carry out printing out without damaging image quality and at preferable printing speed, and a computer-readable recording medium having the program recorded therein.

The invention provides a font downloading apparatus which is connected to an output device holding font shape data for shapes of fonts, and downloads font data of characters existing in a document to the output device in order to allow the output device to carry out printing out of the document including characters of one or more fonts, comprising:

a font readout section for sequentially retrieving individual characters existing in the document and reading out a font type and font size of the individual characters;

a font holding determining section for determining whether font shape data of the characters retrieved by the font readout section is held in the output device based on the font type read out by the font readout means or not;

a font size comparing section for determining whether the font size read out by the font readout section is not larger than a predetermined comparative size or not; and

a font processing section for replacing the font type of the individual characters read out by the font readout section with a font type whose font shape data is held in the output device, when the font holding determining section determines that the font shape data of the character that has been retrieved by the font readout section is not held in the output device, and the font size comparing section determines that the font size that has been read out by the font readout section is not larger than the predetermined comparative size.

In accordance with the invention, at a time of printing out, the individual characters existing in the document are sequentially retrieved to determine whether the font shape data of the characters is held in the output device or not. When the font shape data is not held in the output device, the font size of the individual characters existing in the document is compared to the predetermined comparative size. And when the font size of the characters existing in the document is not larger than the comparative size, the font type of the characters is replaced with the font type existing in the font data held in the output device. Therefore, the font shape data of the fonts having a comparatively small size is not downloaded to the output device and thereby the data traffic is reduced. On the other hand, the font types having a comparatively large size are not replaced. Therefore, the fonts in a comparatively large size are subjected to desired processing such as downloading of the font shape data. This may increase printing speed without deteriorating printing quality.

In the invention, it is preferable that the font downloading apparatus further comprises a comparative size input section for accepting an input of the comparative size from an outside, wherein the font size comparing section determines whether the font size that has been read out by the font readout section is not larger than the size that has been accepted by the comparative size input section or not.

In accordance with the invention, the comparative size for comparing the font size of the individual characters existing in the document may be provided from an outside, thus allowing a user to determine a size that is a threshold value for replacing a font type, by considering priority between printing quality and printing speed.

In the invention it is preferable that the font shape data indicating the shape of the font of the character that has been read out by the font readout section is downloaded to the output device, when the font holding determining section determines that the font shape data of the character that has been retrieved by the font readout section is not held in the output device, and the font size comparing section determines that the font size that has been read out by the font readout section is larger than the predetermined comparative size.

In accordance with the invention, when the font size of the individual characters existing in the document is larger than the comparative size, the font shape data indicating the shape of the font is downloaded to the output device. Therefore, the fonts having a comparatively large size are printed using a font type identical to that used in creation of the document, thus preventing printing quality from deteriorating.

In the invention, it is preferable that the font downloading apparatus further comprises an alternative font table for associating the font of the individual characters existing in the document with the font shape data held in the output device, and the font processing section replaces the font type of the character that has been retrieved by the font readout section with the font type indicating the font shape data associated with the character by the alternative font table, when the font holding determining section determines that the font shape data of the character that has been retrieved by the font readout section is not held in the output device, and the font size comparing section determines that the font size that has been read out by the font readout section is not larger than the predetermined comparative size.

In accordance with the invention, the font alternative table for replacing the font type is provided. This facilitates replacement of the fonts that are not held in the output device with preferable fonts.

The invention provides a font downloading program for downloading font data of characters existing in a document including characters of one or more fonts in order to allow an output device that holds font shape data indicating shapes of fonts, to carry out printing out of the document, the font downloading program allowing a computer to execute a process, comprising:

a font readout step for sequentially retrieving individual characters existing in the document and reading out a font type and font size of the individual characters;

a font holding determining step for determining whether or not the font shape data with respect to the character retrieved at the font readout step is held in the output device based on the font type that has been read out at the font readout step;

a font size comparing step for determining whether the font size read out at the font readout step is not larger than a predetermined comparative size or not;

a font processing step for replacing the font type of the individual characters that has been read out by the font readout step with a font type whose font shape data is held in the output device, when it is determined that the font shape data of the character that has been retrieved at the font readout step is not held in the output device at the font holding determining step, and it is determined that the font size that has been read out at the font readout step is not larger than the predetermined comparative size at the font size comparing step.

The invention provides a font downloading method for downloading font data of characters existing in a document in order to allow an output device that holds font shape data indicating shapes of fonts to carry out printing out of the document having characters of one or more fonts, comprising:

a font readout step for sequentially retrieving individual characters existing in the document and reading out a font type and font size of the individual characters;

a font holding determining step for determining whether or not the font shape data with respect to the character retrieved at the font readout step is held in the output device based on the font type that has been read out at the font readout step;

a font size comparing step for determining whether the font size read out at the font readout step is not larger than a predetermined comparative size or not; and

a font processing step for replacing the font type of the individual characters that has been read out by the font readout step with a font type whose font shape data is held in the output device, when it is determined that the font shape data of the character that has been retrieved at the font readout step is not held in the output device at the font holding determining step, and it is determined that the font size that has been read out at the font readout step is not larger than the predetermined comparative size at the font size comparing step.

The invention provides a computer-readable recording medium having a font downloading program recorded therein, for downloading font data of a character existing in a document in order to allow an output device that holds font shape data indicating a shape of a font to carry out printing out of the document including characters of one or more fonts, the font downloading program allowing a computer to execute a process comprising:

a font readout step for sequentially retrieving individual characters existing in the document and reading out a type and a font size of the individual characters;

a font holding determining step for determining whether or not the font shape data with respect to the character retrieved at the font readout step is held in the output device based on the font type that has been read out at the font readout step;

a font size comparing step for determining whether the font size read out at the font readout step is not larger than a predetermined comparative size or not; and

a font processing step for replacing the font type of the individual characters that has been read out by the font readout step with a font type whose font shape data is held in the output device, when it is determined that the font shape data of the character that has been retrieved at the font readout step is not held in the output device at the font holding determining step, and it is determined that the font size that has been read out at the font readout step is not larger than the predetermined comparative size at the font size comparing step.

### BRIEF DESCRIPTION OF THE DRAWINGS

Other and further objects, features, and advantages of the invention will be more explicit from the following detailed description taken with reference to the drawings wherein:

FIG. 1 is a block diagram illustrating an entire configuration of a document printing system according to one embodiment of the invention;

FIG. 2 is a block diagram illustrating a hardware configuration of a PC in the embodiment;

FIG. 3 is a functional block diagram illustrating a configuration of key functions of the PC in the embodiment;

FIG. 4 is a functional block diagram illustrating a configuration of detailed functions of an output device in the embodiment;

FIG. 5 is a flowchart describing a procedure of printing processing on the PC side in the embodiment;

FIG. 6 shows a font processing selecting screen in the embodiment;

FIG. 7 is a flowchart describing a procedure of the printing processing on the output device side in the embodiment;

FIGS. 8A to 8C show a diagram describing an effect of data traffic reduction in the embodiment;

FIGS. 9A to 9C are a diagram describing an influence on a printing result in the embodiment;

FIG. 10 shows a font processing selecting screen in an example of a related art; and

FIG. 11 is a flowchart describing a procedure of the printing processing on the PC side in the example of the related art.

### DETAILED DESCRIPTION

Now referring to the drawings, preferred embodiments of the invention are described in detail below.

<1. Entire Configuration and Functions>

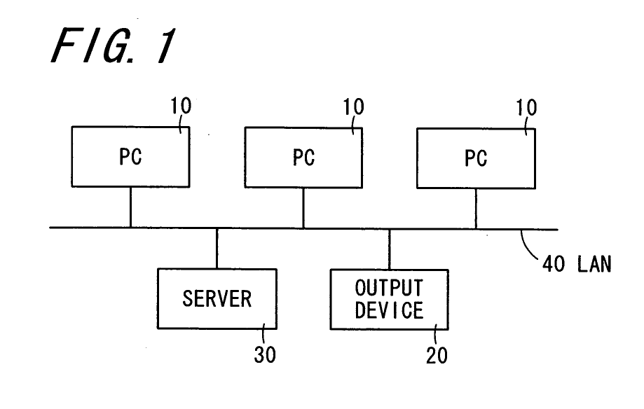

FIG. 1 is a block diagram illustrating an entire configuration of a document printing system according to one embodiment of the invention. The document printing system comprises a plurality of personal computers (hereinafter referred to as “PCs”) 10, an output device (a printer) 20, and a server 30. The plurality of PCs 10, the output device (the printer) 20, and the server 30 are connected to each other via a LAN (Local Area Network) 40. Various application programs are executed on the PC 10. For example, various kinds of documents are created using word-processing software and accounting documents are created using spreadsheet software. In such a case, an operator can use characters having various fonts. The PCs 10 serve as a font downloading apparatus for transferring font data necessary for printing out to the output device 20, when documents and the like created with the application software are printed out from the output device 20. The output device 20 prints out the documents and the like created on the PC 10. There are some fonts (printer fonts) whose font shape data is previously stored in the PC 10. The server 30 serves as a network server for controlling network resources and the like on the LAN 40, a file server for storing common files on the plurality of PCs 10, and the like. Note that this embodiment will be described as a case in which the printer fonts include no True Type fonts.

<2. Hardware Configuration of PC>

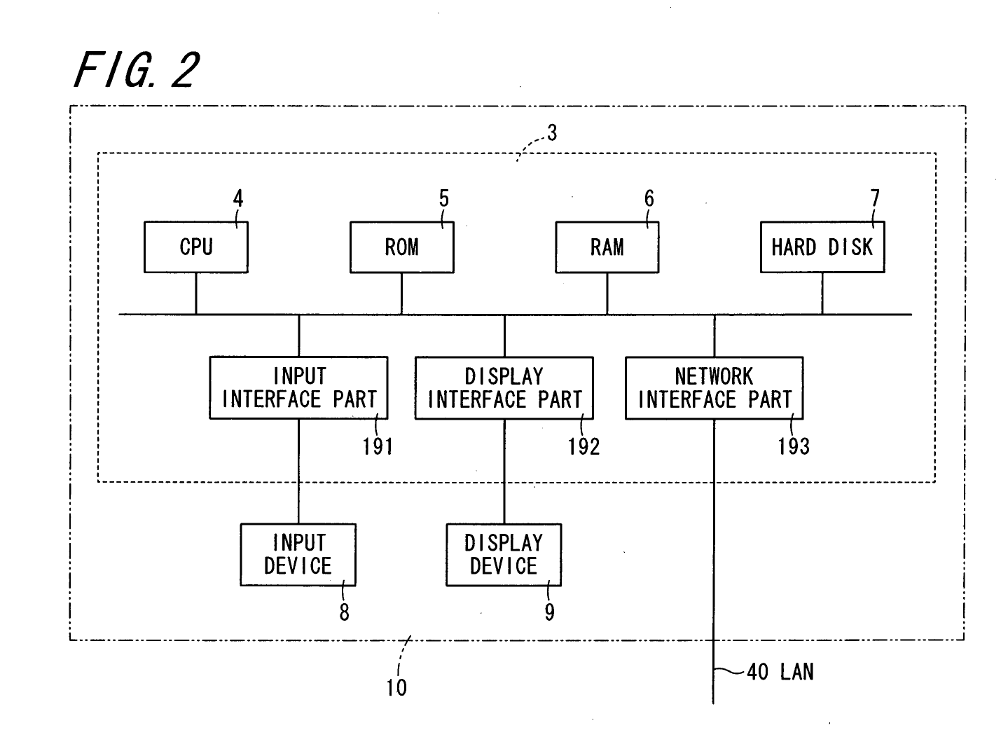

FIG. 2 is a block diagram illustrating a hardware configuration of the PC 10 as the font downloading apparatus in the embodiment. The PC 10 comprises a main body 3, an input device 8 such as a keyboard and a mouse, and a display device 9. The main body 3 includes a CPU (Central Processing Unit) 4, a ROM (Read Only Memory) 5, a RAM (Random Access Memory) 6, a hard disk 7, an input interface part 191, a display interface part 192, and a network interface part 193. The CPU4 performs various arithmetic processing and the like to totally control the PC 10. The ROM 5 is a read only memory and stores a program called a BIOS (Basic Input Output System) executed by the CPU 4 when the PC 10 is started. The RAM 6 is a writable memory and serves as a storage area for temporarily storing active programs and data. The hard disk 7 stores programs for application software, various kinds of data, and the like. The input interface part 191 functions for data communication between the CPU 4 and the input device 8. The display interface part 192 functions for data communication between the CPU 4 and the display device 9. The network interface part 193 functions for data communication between the CPU4 and an outside of the PC 10. The input device 8 is for example a keyboard and a mouse and accepts an input by an operator. The display device 9 displays an image based on a command from the CPU 4.

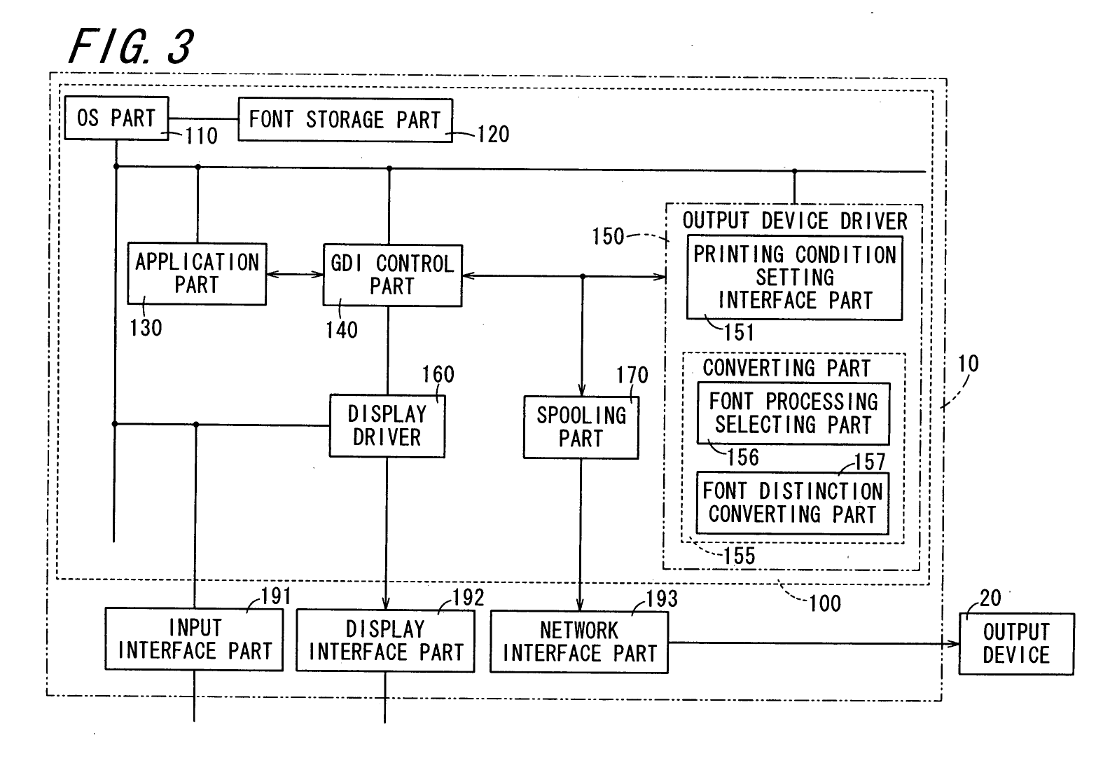

FIG. 3 is a functional block diagram illustrating a configuration of key functions of the PC 10 in the embodiment. The PC 10 includes a processing part 100, the input interface part 191, the display interface part 192, and the network interface part 193, from a functional point of view. The processing part 100 includes an OS (Operating System) part 110, a font storage part 120, an application part 130, a GDI (Graphic Device Interface) control part 140, an output device driver 150, a display driver 160 and a spooling part 170.

The OS part 110 totally manages the PC 10 including execution management of various application software, management of various devices, and the like. For example, functions of the OS part 110 allow the word-processing software to correctly operate, or allow the output device 20 to print out correctly. The font storage part 120 stores data of fonts of characters used for the application software such as the word-processing software. The data of the fonts includes font shape data indicating shapes of the fonts and font identification data for identifying the fonts. In the application part 130, various sorts of application software are executed. For example, documents to be printed out from the output device 20 are created by the word-processing software. The GDI control part 140 functions in cooperation with the display driver 160 such that for example differences displayed on a screen among models or sorts of application software are reduced, and differences specified in specifications among them are absorbed.

The output device driver 150 includes a printing condition setting interface part 151 and a converting part 155. The converting part 155 further includes a font processing selecting part 156 and a font distinction converting part 157. The printing condition setting interface part 151 allows the display device 9 to display a screen (hereinafter referred to as a “printing condition setting screen”) for setting a condition of printing out from the output device 20 in response to a command from the application part 130. The printing condition setting screen includes a font processing selecting screen as will be described later. The converting part 155 converts a document that has been created in the application part 130 into a control code for the output device 20 and a print job containing image data and the like, based on a condition that has been set in the printing condition setting screen. At this time, how to process True Type fonts at a time of printing out is selected from among predetermined items in the font processing selecting part 156. Moreover, in the font distinction converting part 157, it is determined whether True Type fonts are replaced the printer fonts or treated in a predetermined manner at a time of printing out, based on the number of points of the request fonts. The converting part 155 provides a table (an alternative font table) that previously relates True Type fonts to the printer fonts in order to replace True Type fonts with the printer fonts. Note that a detailed description regarding processing of True Type fonts will be described later. Moreover, the printing condition setting screen includes for example a screen for setting print copies, a screen for selecting image quality (print resolution), a screen for setting an N-up print (a function for printing a plurality of pages in one sheet), other than the font processing selecting screen.

The display driver 160 functions so as to allow the display device 9 to achieve a unified display, such as for example minimizing differences in appearance on a screen of the display device 9 among models. The spooling part 170 temporarily holds a print job transmitted from the output device driver 150. This enables sequential printing, when printing of a plurality of documents is continuously instructed.

<3. Configuration and Operation of Output Device>

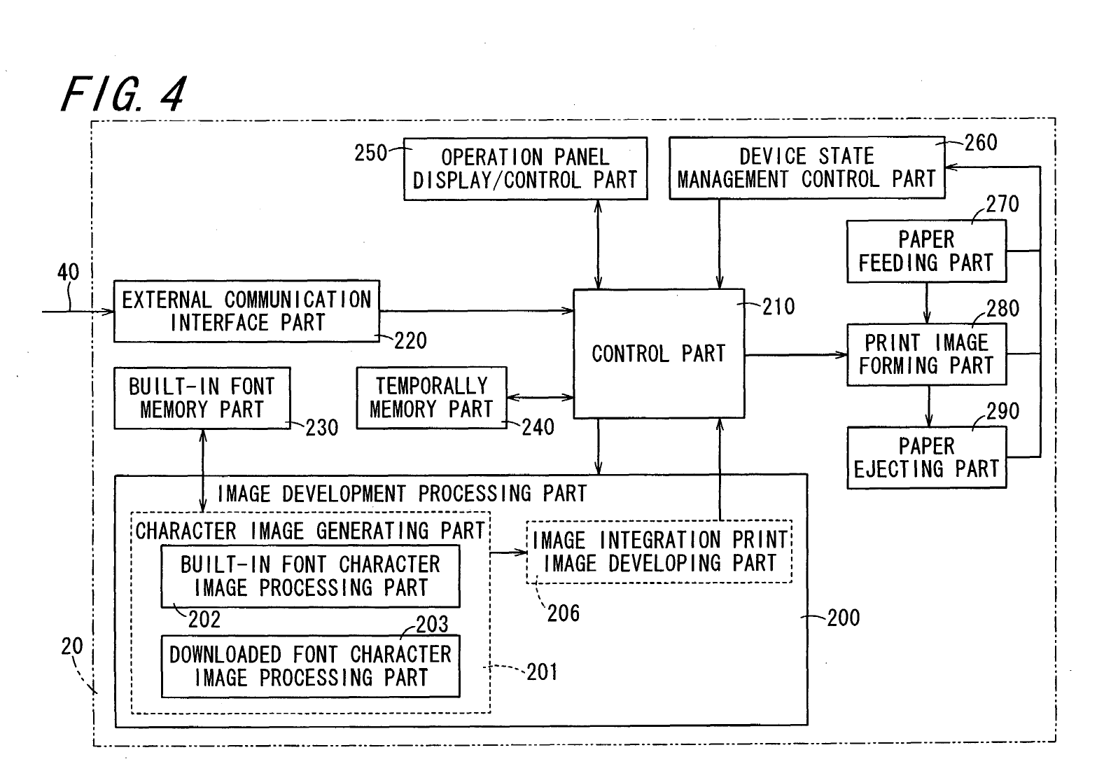

FIG. 4 is a functional block diagram illustrating a configuration of detailed functions of the output device 20. The output device 20 comprises an image development processing part 200, a control part 210, an external communication interface part 220, a built-in font memory part 230, a temporally memory part 240, an operation panel display/control part 250, a device state management control part 260, a paper feeding part 270, a print image forming part 280, and a paper ejecting part 290. The image development processing part 200 includes a character image generating part 201 and an image integration print image developing part 206. The character image generating part 201 further includes a built-in font character image processing part 202 and a downloaded font character image processing part 203.

The external communication interface part 220 receives a print job transmitted from the PC 10 to the LAN 40 and delivers the print job to the control part 210. The control part 210 controls each part to allow the whole of the output device 20 to correctly operate. Moreover, the control part 210 delivers the print job that has been received from the external communication interface part 220 to the image development processing part 200 in order to allow the image development processing part 200 to generate bitmap image data based on the print job. Furthermore, the control part 210 receives the bitmap image data from the image development processing part 200 and delivers it to the print image forming part 280. The built-in font memory part 230 stores shape data (the font shape data) of fonts (the printer fonts). The printer fonts include various shapes and sizes of bitmap fonts and outline fonts. The temporally memory part 240 temporarily holds data necessary for printing out. For example, the print job is temporarily held until printing out based on the print job that has been delivered from the PC 10 is correctly completed.

The image development processing part 200 generates the bitmap image data of a format that can be processed in the print image forming part 280, based on the print job. The built-in font character image processing part 202 generates the bitmap image data based on the font shape data of fonts stored in the built-in font memory part 230. The downloaded font character image processing part 203 generates the bitmap image data based on the font shape data of fonts that have been downloaded from the PC 10. The image integration print image developing part 206 combines the bitmap image data of characters with the bitmap image data such as graphic symbols other than characters, which have been generated in the character image generating part 201, to generate the bitmap image data of a format that can be processed in the print image forming part 280.

The device state management control part 260 monitors a state of each component in the output device 20, such as the paper feeding part 270, the print image forming part 280, and the paper ejecting part 290. The operation panel display/control part 250 displays monitored results obtained by the device state management control part 260, that is, whether a state of each component is normal or abnormal. The paper feeding part 270 stores sheets necessary for printing out, and feeds the sheets into the print image forming part 280 when printing out is executed. Note that it is preferable that the paper feeding part 270 can store several sizes of sheets such as an A4 size sheet and a B5 size sheet. The print image forming part 280 forms an image on a sheet that has been fed from the paper feeding part 270, based on the bitmap image data that has been delivered from the control part 210. The paper ejecting part 290 ejects a sheet on which an image is formed by the print image forming part 280 to an outside.

<4. Printing Processing>

Next, printing processing in the embodiment will be described. When a document that has been created in the PC 10 is printed out from the output device 20, first a setting of a printing condition is made. Then, data to be transferred to the output device 20 is created in the PC 10 based on the printing condition that has been set. The print job refers to the data created in the PC 10. The print job includes, for example image data, character data including the font identification data, the font shape data of fonts to be downloaded to the output device 20, and control codes. The print job that has been created in the PC 10 is transferred to the output device 20 to generate the bitmap image data based on the print job, and then outputted as a printed material. Processing on the personal computer 10 side and on the output device 20 side will be described in turn below. Note that the processing will be described in accordance with an example of printing out a document created with the word-processing software.

<4.1 Processing on PC Side>

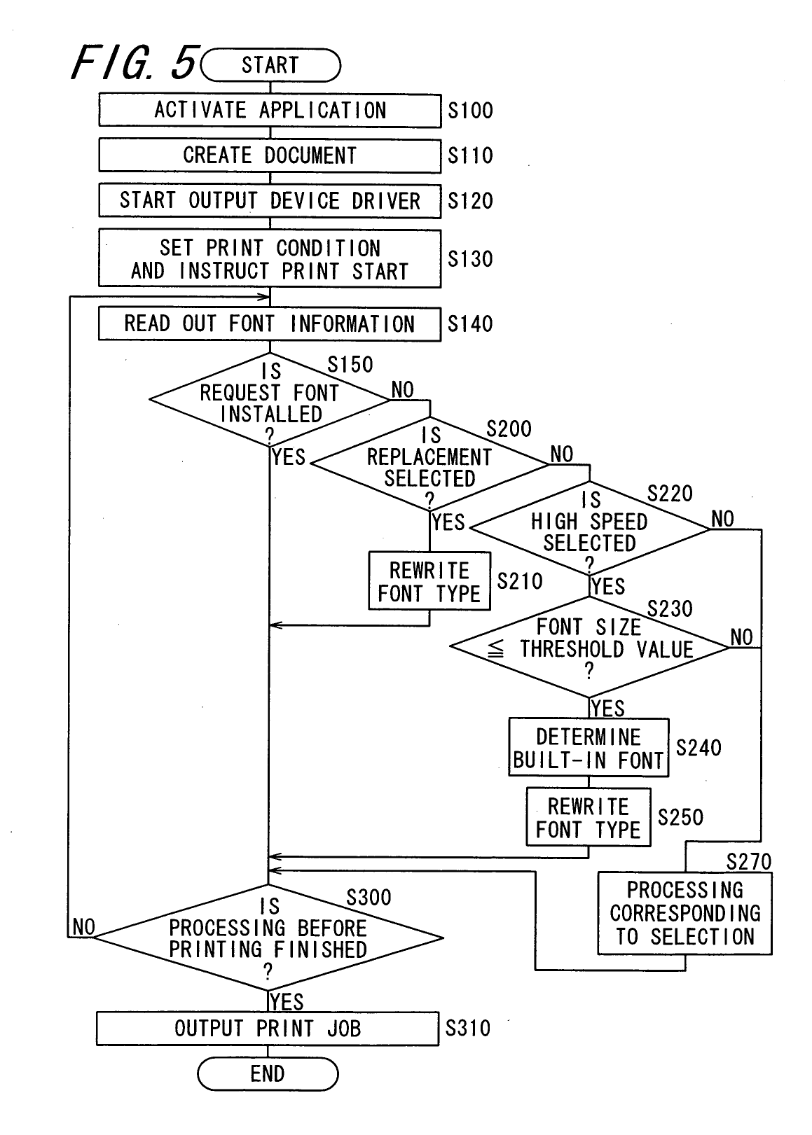

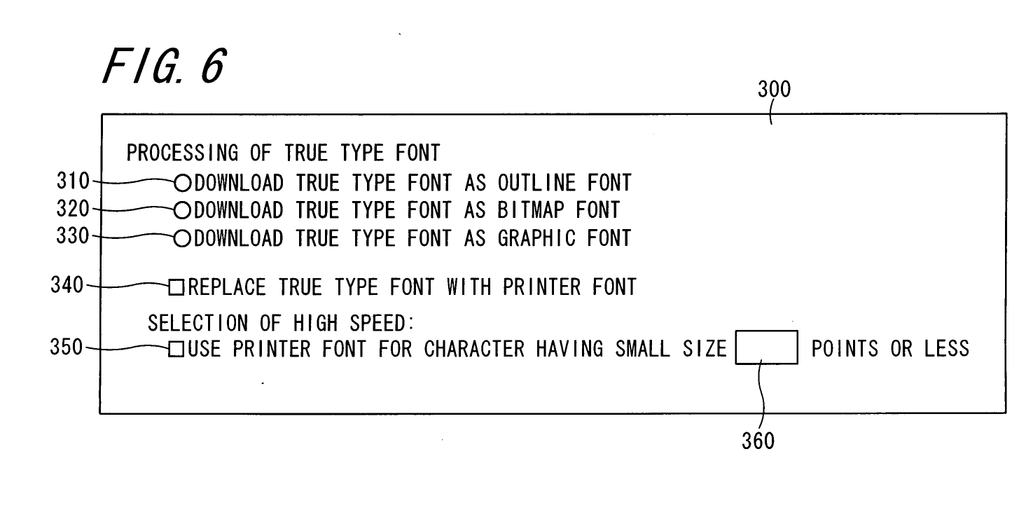

FIG. 5 is a flowchart describing a procedure of the printing processing on the PC 10 side in the embodiment. First, word-processing software is activated in accordance with operator's instructions (for example, so-called clicking on an icon of a desktop) (Step S100). A document to be printed is created with the word-processing software in accordance with operator's operations thereafter (Step S110). At Step S110, font types and font sizes and the like are assigned at a time of inputting characters. Moreover, at Step S110, insertion of image data into the document, and the like are implemented in association with an input of characters. After document creation is completed, the output device driver 150 is started in accordance with operator's instructions (for example selection of a “print menu”) (Step S120). When the output device driver 150 is started, the printing condition setting interface part 151 allows the display device 9 to display a printing condition setting screen. The printing condition setting screen typically comprises a plurality of sub-screens called a tab. FIG. 6 shows a screen (hereinafter referred to as a “font processing selecting screen”) for setting about font processing, which is selected from among the plurality of sub-screens as described above.

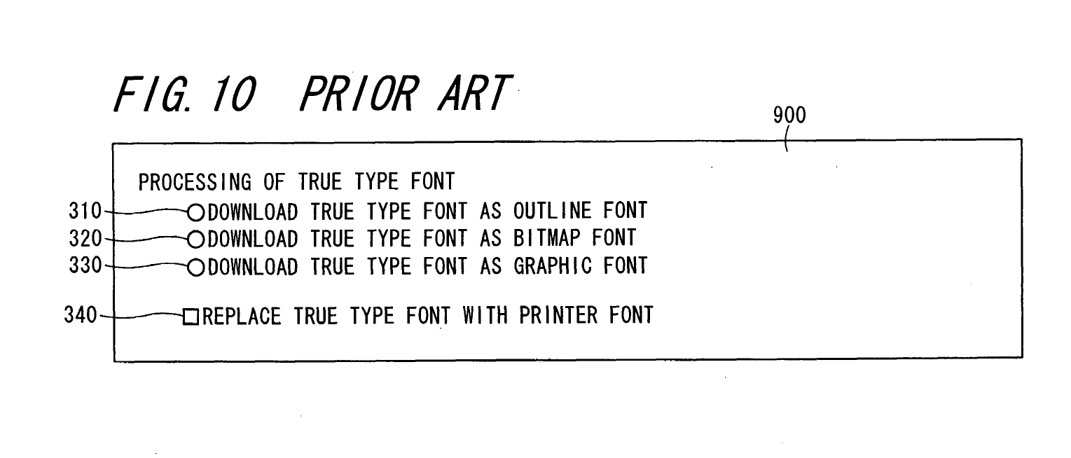

The font processing selecting screen 300 is a screen for allowing an operator to select how to process the fonts for printing when the document created with the word-processing software includes True Type fonts. When the operator selects a first check box 340 in the screen, True Type fonts are replaced with the printer fonts to be printed out. On the other hand, when the operator selects any one of a first optional button 310, a second optional button 320, and a third optional button 330, True Type fonts are not replaced with the printer fonts. For more details, True Type fonts are downloaded as the outline fonts when the first optional button 310 is selected, True Type fonts are downloaded as the bitmap fonts when the second optional button 320 is selected, and True Type fonts are printed as graphic fonts when the third optional button 330 is selected. Additionally, the first check box 340, the first optional button 310, the second optional button 320, and the third optional button 330 as described above are included also in the font processing selecting screen 900 of the related art shown in FIG. 10.

As shown in FIG. 6, the font processing selecting screen 300 in the embodiment further provides a second check box 350 and a text box 360. When the operator inputs a numerical value into the text box 360 to select the second check box 350, True Type fonts having the number of points no more than a value that has been inputted into the text box 360 are replaced with the printer fonts to be printed out. That is, the numerical value that has been inputted into the text box 360 leads to a threshold value for determining whether True Type fonts are replaced with the printer fonts or not. Note that, in the embodiment, the comparative size input section is achieved by the text box 360 as described above.

When a condition is set from the printing condition setting screen including the font processing selecting screen 300 as described above and then a print start is instructed (for example, an “OK” button in the printing condition setting screen is pressed) (Step S130), a process proceeds to Step S140. At Step S140, the output device driver 150 reads out fonts of characters existing in the document. The process proceeds to Step S150 after Step S140 is finished. At Step S150, it is determined whether or not the request fonts present in the printer fonts based on the font identification data of the fonts that have been read out by the output device driver 150. When a determination result is that the request fonts present in the printer fonts, the process proceeds to Step S300, and when the determination result is that the request fonts do not present in the printer fonts, the process proceeds to Step S200. Note that, in the embodiment, the font readout section is achieved through Step S140 and the font holding determination section is achieved through Step S150.

At Step S200, it is determined whether the operator selects the first check box 340 in the font processing selecting screen 300 or not. That is, it is determined whether or not the first check box 340 is selected so as to replace True Type fonts with the printer fonts. When the determination result is that such replacement is selected, the process proceeds to Step S210, and when the determination result is that such replacement is not selected, the process proceeds to Step S220. selected, the process proceeds to Step S220.

At Step S210, types of the fonts that have been read out at Step S140 are rewritten to the printer fonts. The process proceeds to Step S300 after Step S210 is finished.

At Step S220, it is determined whether the operator selects the second check box 350 in the font processing selecting screen 300 or not. That is, it is determined whether the second check box 350 is selected so as to replace True Type fonts having the number of points no more than a predetermined point, with the printer fonts. When the determination result is that such replacement is selected, the process proceeds to Step S230, and when the determination result is that such replacement is not selected, the process proceeds to Step S270.

At Step S230, it is determined whether or not font sizes of the fonts that have been read out at Step S140 are no more than the numerical value (the number of points) that has been inputted into the text box 360 of the font processing selecting screen 300. When the determination result is that the font size is no more than the numerical value that has been inputted into the textbox 360, the process proceeds to Step S240, and when the determination result is that the font size is more than the numerical value that has been inputted into the textbox 360, the process proceeds to Step S270. Note that, achieved through Step S230.

At Step S240, font types that are used for printing out are determined from the fonts that have been read out at Step S140 based on the alternative font table. Font types of the fonts that have been read out at Step S140 are rewritten to the printer fonts thereafter (Step S250). The process proceeds to Step S300, after Step S250 is finished.

At Step S270, the fonts that have been read out at Step S140 are treated with processing corresponding to a result that has been selected by the operator in the font processing selecting screen 300. For more details, True Type fonts are downloaded as the outline fonts when the first optional button 310 is selected, True Type fonts are downloaded as the bitmap fonts when the second optional button 320 is selected, and True Type fonts are printed as graphic fonts when the third optional button 330 is selected. The process proceeds to Step S300 after Step S270 is finished. Note that, in the embodiment, the font processing section is achieved through Step S240, Step S250, and Step S270.

At Step S300, it is determined whether a processing before printing has been finished or not. That is, it is determined whether or not all of the fonts existing in the document have been read out to be each treated with processing corresponding to a condition that has been set in the font processing selecting screen 300, based on the font identification data. When the determination result is that the processing before printing is finished, the process proceeds to Step S310, and when the determination result is that the processing before printing is not finished, the process returns to Step S140.

At Step S310, the print job is outputted. This leads to an end of the printing processing on the personal computer 10 side. Note that the print job that has been outputted at Step S310 is transferred from the PC 10 to the output device 20 via the LAN 40.

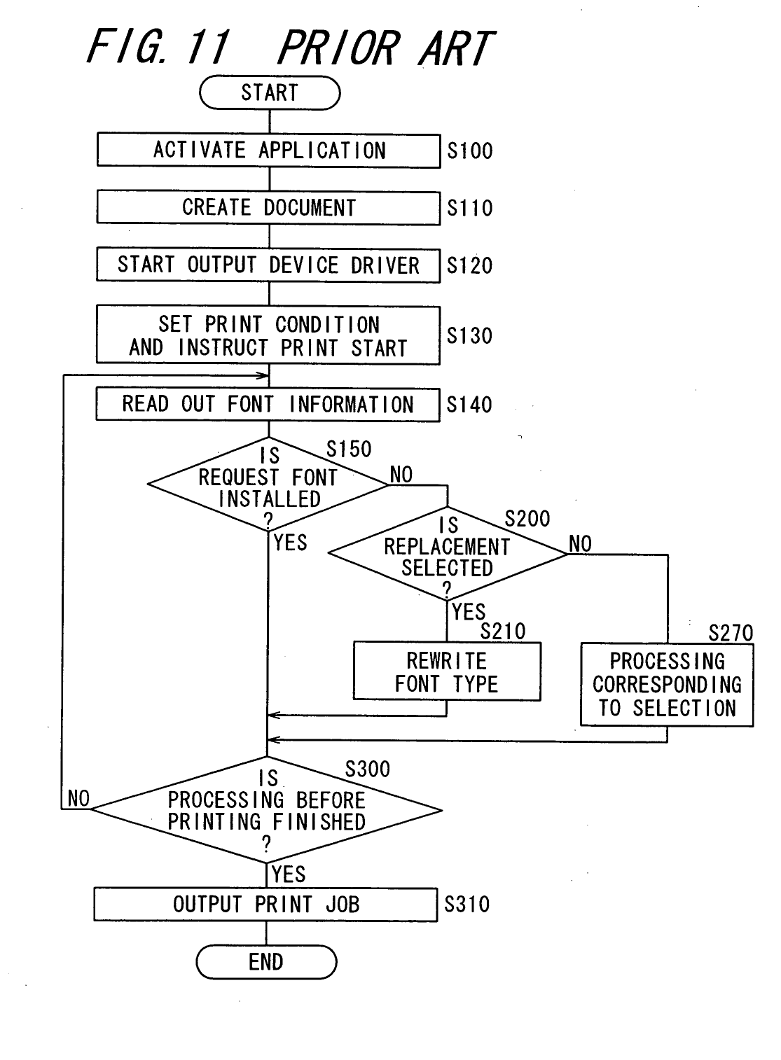

Additionally, FIG. 11 is a flowchart describing a procedure of the printing processing on the PC 10 in an example of a related art. As shown in FIG. 11, in the example of the related art, processing corresponding Step S220, Step S230, Step S240, and Step S250 described in the embodiment has not been implemented. Therefore, an operator has had to select either replacement of all fonts not existing in the printer fonts with the printer fonts or downloading of all the fonts not existing in the printer fonts, notwithstanding sizes of the fonts.

<4.2 Processing on Output Device Side>

Next, a procedure of the printing processing on the output device 20 side will be described. As described above, the print job that has been created at the PC 10 is transferred to the output device 20. While an image forming (printing) on a sheet is implemented in the print image forming part 280 of the output device 20, the print image forming part 280 cannot form an image on the sheet only by directly loading the print job. That is, the print image forming part 280 needs to be provided with the bitmap image data whose format is different from a format of the print job. For this reason, the bitmap image data is generated based on the print job that has been transferred from the PC 10 in the image development processing part 200 of the output device 20.

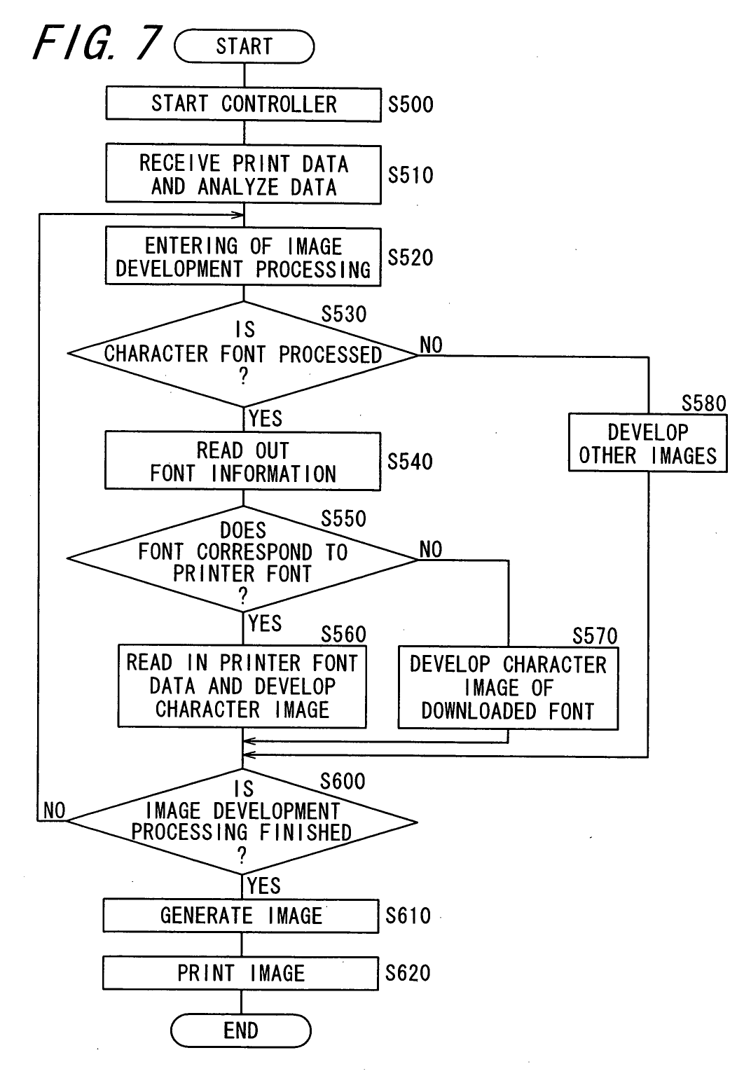

FIG. 7 is a flowchart describing a procedure of the printing processing on the output device 20 side in the embodiment. First, when the output device 20 is powered on, the control part (the controller) 210 is activated (Step S500). Then, when the print job is provided from an outside of the printing device 20, the external communication interface part 220 receives the print job and then a content of the print job is analyzed in the control part 210 (Step S510). The process proceeds to Step S520 and image development processing is started, after Step S510 is finished. For more details, creation of a bitmap from data existing in the print job is started so as to enable the print image forming part 280 to form an image onto a sheet. Note that data already transformed to the bitmap of data existing in the print job is not treated with the image development processing.

The process proceeds to Step S530 and it is determined whether processing (character font processing) for the fonts of the characters is needed or not, after Step S520 is finished. When the determination result is that the character font processing is needed, the process proceeds to Step S540, and when the determination result is that the character font processing is not needed, the process proceeds to Step S580.

At Step S540, the font identification data of the characters is read out. Then, it is determined whether the fonts present in the printer fonts based on the font identification data or not (Step S550). When the determination result is that the fonts present in the printer fonts, the process proceeds to Step S560, and when the determination result is that the fonts do not present in the printer fonts, the process proceeds to Step S570.

At Step S560, the built-in font character image processing part 202 reads out the font shape data from the built-in font memory part 230 to generate the bitmap image data of the fonts. The process proceeds to Step S600, after Step S560 is finished.

At Step S570, the downloaded font character image processing part 203 generates the bitmap image data of the fonts based on the font shape data that has been downloaded from the PC 10. The process proceeds to S600, after Step S570 is finished.

At Step S580, data other than characters, such as for example graphic data, is transformed to the bitmap. The process proceeds to Step S600, after Step S580 is finished.

At Step S600, it is determined whether the image development processing is finished or not. When the determination result is that the image development processing is finished, the process proceeds to Step S610, and when the determination result is that the image development processing is not finished, the process returns to Step S520. At Step S610, the image integration print image developing part 206 combines the bitmap image data other than the characters with the bitmap image data of the characters that have been generated at Step S560 and Step S570. The bitmap image data that can be processed in the print image forming part 280 is thus generated. Subsequently, the image forming processing is implemented based on the bitmap image data that has been generated at Step S610 (Step S620). For more details, the print image forming part 280 forms (prints) an image onto a print sheet based on the bitmap image data. This leads to an end of the printing processing on the output device 20 side.

<5. Effect>

In accordance with the embodiment, when the print job is generated in the PC 10 to carry out printing out of a document and the like, an operator selects how to download data of True Type fonts existing in the document. At this time, the operator can assign the number of points of fonts, and thereby set so that the printer fonts are applied for printing out, with respect to fonts having the number of points no more than the number of points that has been assigned. The output device driver 150 in the PC 10 generates the print job in accordance with the operator's assignment. Accordingly, when True Type font has the number of points more than the number of points that has been assigned, the font shape data is downloaded, and when True Type font has the number of points no more than the number of points that has been assigned, the font shape data is not downloaded.

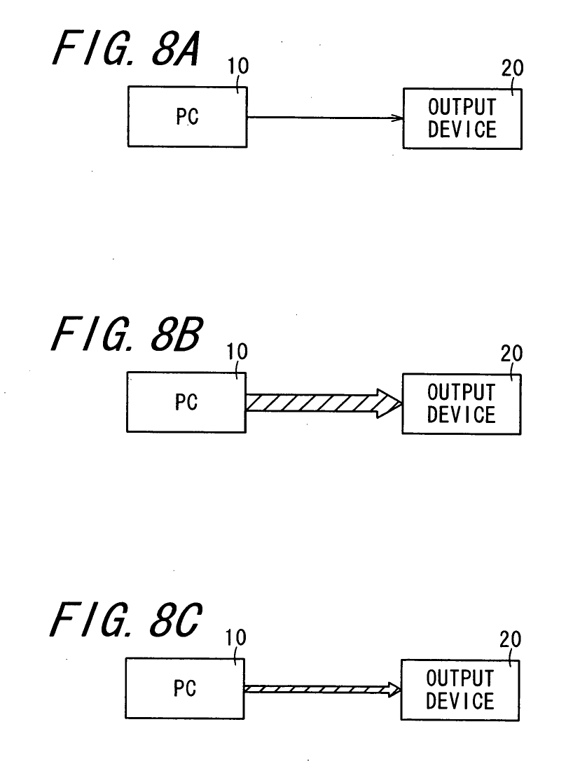

FIGS. 8A to 8C show a diagram describing an effect of reduction of data traffic from the PC 10 to the output device 20. FIG. 8A schematically shows the data traffic when fonts of all characters existing in a document are the printer fonts. The data traffic in this case shows similar results both in the related art example and in the embodiment. FIG. 8B schematically shows the data traffic when fonts other than the printer fonts exist in a document in the related art example. FIG. 8C schematically shows the data traffic when fonts other than the printer fonts exist in a document in the embodiment. As described above, in the embodiment, when True Type fonts, which do not exist in the printer fonts, have the number of points no more than the number of points that has been assigned, types of the fonts are replaced with types of the fonts existing in the printer fonts, thus preventing downloading of the font shape data. Therefore, as shown in FIGS. 8B and 8C, in accordance with the embodiment, the data traffic from the PC 10 to the output device 20 is reduced below the data traffic in the related art example.

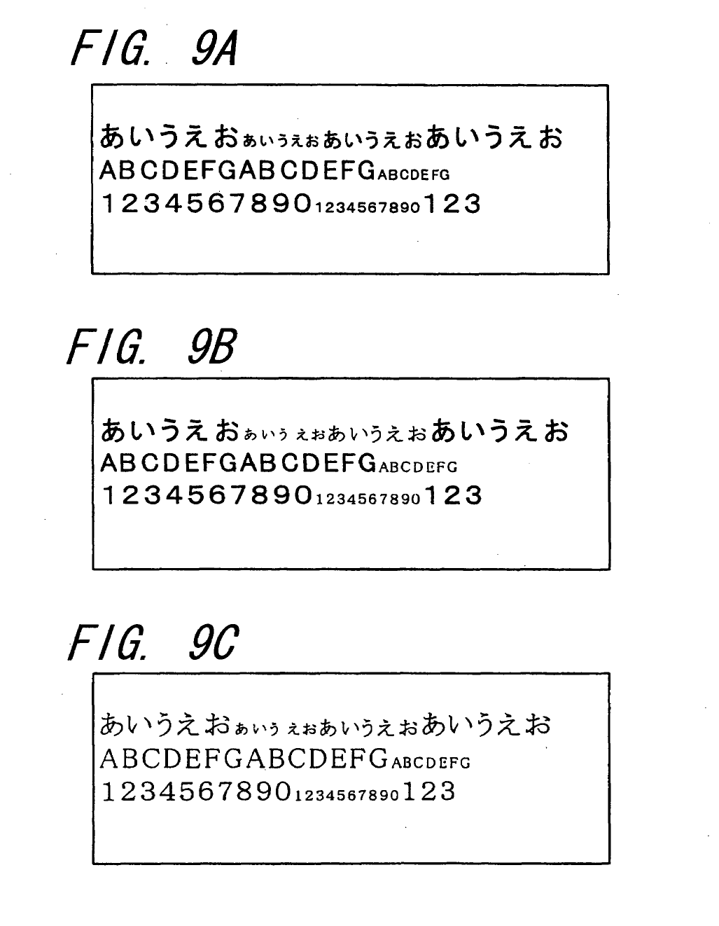

Here, when the font shape data of characters having a comparatively small size is not downloaded, the effect on a printing result will be described referring to FIGS. 9A to 9C. FIG. 9A shows one example of a document (a source document to be printed) that has been created in the PC 10. FIG. 9C shows one example of a printed result when all characters in the document of FIG. 9A are replaced with the printer fonts. Compared with FIG. 9C, FIG. 9B shows one example of a printed result when only fonts of characters having a comparatively small size in the document of FIG. 9A are replaced to the printer fonts. Differences in appearance between FIG. 9A and FIG. 9B are smaller than differences in appearance between FIG. 9A and FIG. 9C. Therefore, it can be said that fonts of characters having a comparatively small size have a comparatively small deterioration in image quality, even after such fonts are replaced with the printer fonts.

As described above, in accordance with the embodiment, when fonts not existing in the printer fonts have comparatively large sizes, the font shape data is downloaded to put a high priority on appearance of the fonts, and when such fonts have comparatively small sizes, the font shape data is not downloaded to put a high priority on printing speed. As a result, the printing speed can be increased more than the printing speed in the related art, while deterioration in image quality is controlled. Moreover, an operator can assign the comparative sizes in the font processing selecting screen 300. Therefore, it is possible to print out, by considering which one has priority, printing quality or printing speed.

<6. Others>

In the embodiment as described above, the threshold value for determining whether the request fonts are replaced with the printer fonts or not is determined by the operator's assignment in the font processing selecting screen 300. In the invention, there is no limitation to this. For example, the output device driver 150 may hold a predetermined threshold value, or may be configured so that the threshold value is set by a separated operation from the printing processing.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A font downloading apparatus which is connected to an output device holding font shape data for shapes of fonts, and downloads font data of characters existing in a document to the output device in order to allow the output device to carry out printing out of the document including characters of one or more fonts, comprising:
a font readout section for sequentially retrieving individual characters existing in the document and reading out a font type and font size of the individual characters;
a font holding determining section for determining whether font shape data of the-characters retrieved by the font readout section is held in the output device based on the font type read out by the font readout means or not;
a font size comparing section for determining whether the font size read out by the font readout section is not larger than a predetermined comparative size or not; and
a font processing section for replacing the font type of the individual characters read out by the font readout section with a font type whose font shape data is held in the output device, when the font holding determining section determines that the font shape data of the character that has been retrieved by the font readout section is not held in the output device, and the font size comparing section determines that the font size that has been read out by the font readout section is not larger than the predetermined comparative size.

2. The font downloading apparatus of claim 1, further comprising a comparative size input section for accepting an input of the comparative size from an outside,
wherein the font size comparing section determines whether the font size that has been read out by the font readout section is not larger than the size that has been accepted by the comparative size input section or not.

3. The font downloading apparatus of claim 1, wherein the font processing section downloads the font shape data indicating the shape of the font of the character that has been read out by the font readout section to the output device, when the font holding determining section determines that the font shape data of the character that has been retrieved by the font readout section is not held in the output device, and the font size comparing section determines that the font size that has been read out by the font readout section is larger than the predetermined comparative size.

4. The font downloading apparatus of claim 1, further comprising an alternative font table for associating the font of the individual characters existing in the document with the font shape data held in the output device,
wherein the font processing section replaces the font type of the character that has been retrieved by the font readout section with the font type indicating the font shape data associated with the character by the alternative font table, when the font holding determining section determines that the font shape data of the character that has been retrieved by the font readout section is not held in the output device, and the font size comparing section determines that the font size that has been read out by the font readout section is not larger than the predetermined comparative size.

5. A font downloading program for downloading font data of characters existing in a document including characters of one or more fonts in order to allow an output device that holds font shape data indicating shapes of fonts, to carry out printing out of the document, the font downloading program allowing a computer to execute a process, comprising:
a font readout step for sequentially retrieving individual characters existing in the document and reading out a font type and font size of the individual characters;
a font holding determining step for determining whether or not the font shape data with respect to the character retrieved at the font readout step is held in the output device based on the font type that has been read out at the font readout step;
a font size comparing step for determining whether the font size read out at the font readout step is not larger than a predetermined comparative size or not;
a font processing step for replacing the font type of the individual characters that has been read out by the font readout step with a font type whose font shape data is held in the output device, when it is determined that the font shape data of the character that has been retrieved at the font readout step is not held in the output device at the font holding determining step, and it is determined that the font size that has been read out at the font readout step is not larger than the predetermined comparative size at the font size comparing step.

6. A font downloading method for downloading font data of characters existing in a document in order to allow an output device that holds font shape data indicating shapes of fonts to carry out printing out of the document having characters of one or more fonts, comprising:
a font readout step for sequentially retrieving individual characters existing in the document and reading out a font type and font size of the individual characters;
a font holding determining step for determining whether or not the font shape data with respect to the character retrieved at the font readout step is held in the output device based on the font type that has been read out at the font readout step;
a font size comparing step for determining whether the font size read out at the font readout step is not larger than a predetermined comparative size or not; and
a font processing step for replacing the font type of the individual characters that has been read out by the font readout step with a font type whose font shape data is held in the output device, when it is determined that the font shape data of the character that has been retrieved at the font readout step is not held in the output device at the font holding determining step, and it is determined that the font size that has been read out at the font readout step is not larger than the predetermined comparative size at the font size comparing step.

7. A computer-readable recording medium having a font downloading program recorded therein, for downloading font data of a character existing in a document in order to allow an output device that holds font shape data indicating a shape of a font to carry out printing out of the document including characters of one or more fonts, the font downloading program allowing a computer to execute a process comprising:
a font readout step for sequentially retrieving individual characters existing in the document and reading out a type and a font size of the individual characters;
a font holding determining step for determining whether or not the font shape data with respect to the character retrieved at the font readout step is held in the output device based on the font type that has been read out at the font readout step;
a font size comparing step for determining whether the font size read out at the font readout step is not larger than a predetermined comparative size or not; and
a font processing step for replacing the font type of the individual characters that has been read out by the font readout step with a font type whose font shape data is held in the output device, when it is determined that the font shape data of the character that has been retrieved at the font readout step is not held in the output device at the font holding determining step, and it is determined that the font size that has been read out at the font readout step is not larger than the predetermined comparative size at the font size comparing step.
